(19) United States
(12) Patent Application Publication
(10) Pub. No.: US 2020/0079917 A1
(43) Pub. Date: Mar. 12, 2020

(54) METHOD FOR PRODUCING FIBER-REINFORCED COMPOSITE MATERIAL

(71) Applicant: Toray Industries, Inc., Tokyo (JP)

(72) Inventors: Kentaro Sano, Iyo-gun, Ehime (JP); Ayumi Mori, Iyo-gun, Ehime (JP); Taiki Kuroda, Iyo-gun, Ehime (JP); Toshiya Kamae, Iyo-gun, Ehime (JP)

(73) Assignee: Toray Industries, Inc., Tokyo (JP)

(21) Appl. No.: 16/611,344

(22) PCT Filed: Apr. 5, 2018
(86) PCT No.: PCT/JP2018/014539

§ 371 Date: Nov. 6, 2019

(30) Foreign Application Priority Data
May 10, 2017 (JP) 2017-093711

(51) Int. Cl. C08J 5/04; B29C 70/44

(52) U.S. Cl. CPC C08J 5/042; B29K 2063/00; C08J 2363/00; B29C 70/44

(57) ABSTRACT

Provided is a method for producing a fiber-reinforced composite material exhibiting high heat resistance and excellent appearance quality. It is a method for producing a fiber-reinforced composite material, which includes disposing a prepreg containing a reinforced fiber being impregnated with an epoxy resin composition in a mold, pressurizing and heating the prepreg at 0.2 to 2.5 MPa and 130° C. to 200° C. as primary curing, and then further heating the prepreg at 210° C. to 270° C. for 10 minutes or more as secondary curing.

### CROSS REFERENCE TO RELATED APPLICATIONS

This is the U.S. National Phase application of PCT/JP2018/014539, filed Apr. 5, 2018, which claims priority to Japanese Patent Application No. 2017-093711, filed May 10, 2017, the disclosures of these applications being incorporated herein by reference in their entireties for all purposes.

### FIELD OF THE INVENTION

The present invention relates to a method for producing a fiber-reinforced composite material suitable for sports applications and general industrial applications by pressure molding.

### BACKGROUND OF THE INVENTION

Fiber-reinforced composite materials in which carbon fibers, aramid fibers and the like are used as reinforced fibers are widely utilized in structural materials such as aircraft and motor vehicles, sports applications such as tennis and badminton rackets, golf shafts, fishing rods, and bicycles, general industrial applications and the like to make use of the high specific strength and specific elastic modulus thereof.

In such applications, an internal pressure molding method is often used as a method for molding a hollow molded article having a complicated shape such as a golf shaft, a fishing rod, a bicycle, a racket or the like. The internal pressure molding method is a method in which a preform in which a prepreg is wound on an internal pressure applying member such as a tube made of a thermoplastic resin is set in a mold and then a high pressure gas is introduced into the internal pressure applying member to apply pressure to the preform and, at the same time, the mold is heated for molding. In addition, as a method for molding a molded article having a relatively simple shape such as a housing or a motor vehicle part, a press molding method is often used.

In recent years, fiber-reinforced composite materials have been more and more used in turbine cases of aircraft, outer plate members of motor vehicles, rim materials of bicycles and the like, and high heat resistance is required for these applications. For example, heat is generated at the rims of bicycles by friction with brake shoes at the time of braking and the rim temperature extremely increases, and thus a fiber-reinforced composite material exhibiting higher heat resistance than before is demanded.

Generally, in order to obtain a fiber-reinforced composite material exhibiting high heat resistance, it is required to mold the fiber-reinforced composite material at a high molding temperature. In addition, the viscosity of thermosetting resin usually decreases at a high temperature. In the internal pressure molding method and press molding method described above, the viscosity of the thermosetting resin at the curing temperature decreases in a case in which the curing temperature in press molding is raised to enhance the heat resistance of the fiber-reinforced composite material, thus the thermosetting resin unnecessarily flows too much, and problems arise in the appearance quality such as deterioration in the surface appearance due to disturbance of the reinforced fibers, embossing of reinforced fibers on the surface of the molded article, and resin blurring. In addition, it takes time to raise and lower the temperature in a case in which the curing temperature in press molding is increased, and thus problems arise that the mold occupancy time for one time of molding is lengthened and the productivity deteriorates.

As a method for producing a fiber-reinforced composite material by internal pressure molding or press molding, Patent Document 1 discloses a production method in which resin flow at the time of molding is controlled using a resin composition in which thickening particles are blended. Patent Document 2 discloses a method for producing a fiber-reinforced composite material exhibiting favorable surface appearance by defining the relation between applied pressure and viscosity and the minimum viscosity. Patent Document 3 discloses a technique for optimizing resin flow using a resin composition having a specific gel time in a press molding method at an applied pressure of 3 MPa or more.

### PATENT DOCUMENTS

Patent Document 1: National Publication of International Patent Application No. 2015-080035

Patent Document 2: Japanese Patent Laid-open Publication No. 2012-196921

Patent Document 3: Japanese Patent Laid-open Publication No. 2004-331748

### SUMMARY OF THE INVENTION

However, by the production methods described in Patent Documents 1 and 2, fiber-reinforced composite materials exhibiting excellent appearance quality are obtained but the heat resistance thereof is insufficient. In addition, the production method described in Patent Document 3 is suitable for an applied pressure of 3 MPa or more, but it cannot be said that the production method has sufficient performance to be applied in the case of performing molding at a lower pressure. Furthermore, by the production method described in Patent Document 3 as well, the fiber-reinforced composite material obtained exhibits insufficient heat resistance.

An object of the present invention is to ameliorate the disadvantages of the prior arts and thus to provide a method for producing a fiber-reinforced composite material by which a fiber-reinforced composite material which exhibits high heat resistance and excellent appearance quality and is suitable for various applications such as sports applications or general industrial applications can be obtained.

The present inventors have conducted intensive investigations to solve the above-mentioned problems, as a result, found out that a fiber-reinforced composite material exhibiting excellent heat resistance and appearance quality can be produced by satisfying specific production conditions, and thus completed the present invention. In other words, the present invention consists of the following configuration.

A method for producing a fiber-reinforced composite material, the method including: disposing a prepreg containing a reinforced fiber being impregnated with an epoxy resin composition in a mold; pressurizing and heating the prepreg at 0.2 to 2.5 MPa and 130° C. to 200° C. as primary curing; and then further heating the prepreg at 210° C. to 270° C. for 10 minutes or more as secondary curing.

According to the method for producing a fiber-reinforced composite material of the present invention, it is possible to obtain a fiber-reinforced composite material exhibiting high heat resistance and excellent appearance quality.

### DETAILED DESCRIPTION OF EMBODIMENTS OF THE INVENTION

The method for producing a fiber-reinforced composite material of the present invention includes disposing a prepreg containing a reinforced fiber being impregnated with an epoxy resin composition in a mold; pressurizing and heating the prepreg at 0.2 to 2.5 MPa and 130° C. to 200° C. as primary curing; and then further heating the prepreg at 210° C. to 270° C. for 10 minutes or more as secondary curing.

In the method for producing a fiber-reinforced composite material of the present invention, the pressure at the time of the primary curing is required to be 0.2 to 2.5 MPa and is preferably 0.3 to 2.0 MPa and more preferably 0.4 to 1.5 MPa. It is possible to attain proper fluidity of resin and to prevent poor appearance such as generation of pits when the pressure is 0.2 MPa or more. Moreover, the prepreg sufficiently comes into close contact with the mold, and thus a fiber-reinforced composite material having a favorable appearance can be produced. When the pressure is 2.5 MPa or less, the resin does not flow more than necessary, thus occurring of fiber disturbance and resin blurring can be prevented, and the fiber-reinforced composite material to be obtained hardly has poor appearance. In addition, a load is not applied to the mold more than necessary, and thus deformation of the mold and the like hardly occur. Furthermore, flexible internal pressure bags such as nylon and silicon rubber to be used in the internal pressure molding method are hardly destroyed.

In addition, in the method for producing a fiber-reinforced composite material of the present invention, the temperature at the time of the primary curing is 130° C. to 200° C. When the primary curing temperature is 130° C. or more, the epoxy resin composition to be used in the present invention can sufficiently undergo the curing reaction and a fiber-reinforced composite material can be obtained with high productivity. In addition, when the primary curing temperature is 200° C. or less, it is possible to suppress disturbance of reinforced fibers due to excessive resin flow and to obtain a fiber-reinforced composite material exhibiting excellent appearance quality. Furthermore, it is possible to shorten the mold occupancy time and to obtain a fiber-reinforced composite material with high productivity. The primary curing temperature is preferably 150° C. to 190° C. and more preferably 160° C. to 185° C. from the viewpoint of productivity and appearance quality. In addition, it is preferable to set the primary curing time to 15 to 120 minutes. The epoxy resin composition to be used in the present invention can sufficiently undergoes the curing reaction as the primary curing time is set to 15 minutes or more, and the mold occupancy time can be shortened and a fiber-reinforced composite material can be obtained with high productivity as the primary curing time is set to 120 minutes or less.

In the method for producing a fiber-reinforced composite material of the present invention, it is required to further performing heating at 210° C. to 270° C. for 10 Minutes or more as secondary curing after the primary curing. By performing this heating step (secondary curing), it is possible to obtain a fiber-reinforced composite material exhibiting excellent heat resistance without deteriorating the appearance quality. A fiber-reinforced composite material exhibiting excellent heat resistance is obtained when the heating temperature is 210° C. or more. When the heating temperature is 270° C. or less, the epoxy resin composition is not decomposed by heat and a fiber-reinforced composite material exhibiting excellent heat resistance and strength can be obtained. In addition, the heating temperature is set to more preferably 220° C. to 255° C. and still more preferably 230° C. to 250° C. from the viewpoint of heat resistance. In addition, a fiber-reinforced composite material exhibiting excellent heat resistance can be obtained when the secondary curing time is 10 minutes or more, and the secondary curing time is more preferably 20 minutes or more.

It is preferable that the glass transition temperature of a cured product obtained by subjecting the epoxy resin composition to be used in the present invention to a curing at 180° C. for 30 minutes and then further to a curing at 240° C. for 30 minutes is 220° C. or more. A fiber-reinforced composite material exhibiting excellent heat resistance is obtained by performing secondary curing using an epoxy resin composition of which the cured product has a glass transition temperature of 220° C. or more.

Here, the glass transition temperature is an onset temperature of the storage elastic modulus when the temperature is raised from 40° C. to 270° C. at a temperature raising rate of 5° C./min and the storage elastic modulus is measured in a bending mode at a frequency of 1.0 Hz using a dynamic viscoelasticity measuring apparatus (DMAQ800: manufactured by TA Instruments).

It is preferable that the epoxy resin composition to be used in the present invention has a resin viscosity (η40) at 40° C. and a minimum viscosity (ηmin) satisfying: 2.5≤Log(η40)−Log(ηmin)≤3.5. Here, η40 and ηmin are values attained by setting the epoxy resin composition so that the distance between the upper and lower jigs is 1 mm and then measuring the viscosity at a temperature raising rate of 1.5° C./min in a measurement temperature range of 40° C. to 160° C. in a torsion mode (measurement frequency: 0.5 Hz) using a dynamic viscoelasticity apparatus ARES-2KFRTN1-FCO-STO (manufactured by TA Instruments) and a flat parallel plate with a diameter of 40 mm as the upper and lower measurement jigs.

As η40 and ηmin satisfy the above relational expression, the amount of resin flowing in the epoxy resin composition is in a proper range when the epoxy resin composition is pressurized at 0.2 to 2.5 MPa and subjected to primary curing and a fiber-reinforced composite material exhibiting excellent appearance quality is likely to be obtained. When Log(η40)−Log(ηmin) is 2.5 or more, proper resin flow occurs and pits on the surface of the fiber-reinforced composite material to be obtained can be suppressed. When Log(η40)−Log(ηmin) is 3.5 or less, it is possible to suppress disturbance of reinforced fibers and resin blurring due to excessive resin flow. The value of Log(η40)−Log(ηmin) is more preferably 2.8 or more and 3.2 or less.

It is preferable that the minimum viscosity is in a range of 90° C. to 120° C. when the viscosity of the epoxy resin composition to be used in the present invention is measured at a temperature raising rate of 1.5° C./min, and the value of the minimum viscosity is 4.0 Pa·s or less. As the minimum viscosity is at 90° C. to 120° C. and is 4.0 Pa·s or less, the amount of resin flowing is optimized and a fiber-reinforced composite material exhibiting superior appearance quality is obtained.

The epoxy resin composition to be used in the present invention is preferably an epoxy resin composition containing constituents [A] to [C].

[A] a tri- or higher functional epoxy resin having an aromatic ring
[B] an aromatic amine curing agent
[C] a curing accelerator

A tri- or higher functional epoxy resin having an aromatic ring which is the constituent [A] of the epoxy resin composition in the present invention is preferably blended since this epoxy resin enhances the heat resistance of the fiber-reinforced composite material to be obtained. Examples of such an epoxy resin include novolac epoxy resins such as a phenol novolac epoxy resin and a cresol novolac epoxy resin, biphenyl aralkyl epoxy resins and zylock epoxy resins, and glycidylamine epoxy resins such as N,N,O-triglycidyl-m-aminophenol, N,N,O-triglycidyl-p-aminophenol, N,N,O-triglycidyl-4-amino-3-methylphenol, tetraglycidyldiaminodiphenylmethane, triglycidylaminophenol, triglycidylaminocresol, and tetraglycidylxylenediamine.

An aromatic amine curing agent which is the constituent [B] of the epoxy resin composition in the present invention is preferably blended since this curing agent enhances the heat resistance of the fiber-reinforced composite material to be obtained. Examples of such an aromatic amine curing agent include 4,4′-diaminodiphenylmethane, 4,4′-diaminodiphenyl sulfone, 3,3′-diaminodiphenyl sulfone, m-phenylenediamine, m-xylylenediamine, and diethyltoluenediamine. Among these, 4,4′-diaminodiphenyl sulfone and 3,3′-diaminodiphenyl sulfone are suitably used because of excellent heat resistance thereof.

As a curing accelerator which is the constituent [C] of the epoxy resin composition in the present invention is blended, the reactivity at a low temperature is improved, excessive resin flow is suppressed, and thus a-fiber reinforced composite material exhibiting excellent appearance quality is likely to be obtained. Examples of such a curing accelerator include aromatic urea and imidazole compounds, and imidazole compounds are suitably used from the viewpoint of heat resistance. Examples of the aromatic urea include 3-(3,4-dichlorophenyl)-1,1-dimethylurea, 3-(4-chlorophenyl)-1,1-dimethylurea, phenyldimethylurea, and toluenebisdimethylurea. Moreover, as commercially available products of aromatic urea, DCMU99 (manufactured by Hodogaya Chemical Co., Ltd.), “Omicure (registered trademark)” 24 (made by PTI Japan Limited), and the like can be used.

Examples of the imidazole compound include 1-benzyl-2-methylimidazole, 1-benzyl-2-ethylimidazole, 1-cyanoethyl-2-methylimidazole, 1-cyanoethyl-2-ethyl-4-methylimidazole, 1-cyanoethyl-2-phenylimidazole, and 2-methylimidazole. The imidazole compound may be used singly or in combination of plural kinds thereof. Furthermore, the imidazole compound is preferably a reaction product of an imidazole compound and a bisphenol epoxy. An epoxy resin composition in which a reaction product of an imidazole compound and a bisphenol epoxy is blended exhibits an excellent balance between reactivity at a low temperatures and stability near room temperature. Examples of commercially available products of such a reaction product of an imidazole compound and a bisphenol epoxy include “CUREDUCT (registered trademark)” P-0505 (SHIKOKU CHEMICALS CORPORATION) and “jER Cure (registered trademark)” P200H50 (Mitsubishi Chemical Corporation).

The tri- or higher functional epoxy resin having an aromatic ring of the constituent [A] is preferably contained in an amount of 80 parts by mass or more in 100 parts by mass of all epoxy resins in the epoxy resin composition. As the amount of constituent [A] blended is set to 80 parts by mass or more, a fiber-reinforced composite material exhibiting excellent heat resistance is likely to be obtained, and the constituent [A] is more preferably blended at 90 parts by mass or more.

It is preferable that the tri- or higher functional epoxy resin having an aromatic ring of the constituent [A] includes any one of tetraglycidyldiaminodiphenylmethane, a novolac epoxy resin, or an epoxy resin represented by Formula (i) since a fiber-reinforced composite material exhibiting excellent heat resistance is likely to be obtained. Among these, an epoxy resin represented by Formula (i) is suitably used since this epoxy resin exhibits excellent heat resistance and resin flow property and a fiber-reinforced composite materials exhibiting favorable appearance quality is likely to be obtained.

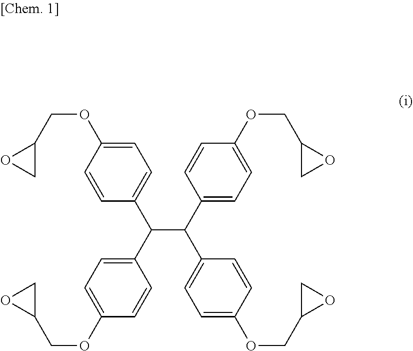 [SMILES: c1cc(C(c2ccc(OCC3CO3)cc2)C(c2ccc(OCC3CO3)cc2)c2ccc(OCC3CO3)cc2)ccc1OCC1CO1]

Examples of commercially available products of tetraglycidyl diaminodiphenylmethane include “SUMI-EPDXY (registered trademark)” ELM434 (manufactured by Sumitomo Chemical Co., Ltd.) and “Araldite (registered trademark)” MY721 (manufactured by Huntsman Advanced Materials K.K.). Examples of commercially available products of the novolac epoxy resin include “jER (registered trademark)” 157S70 (manufactured by Mitsubishi Chemical Corporation), “jER (registered trademark)” 1032H60 (manufactured by Mitsubishi Chemical Corporation), and NC7300L (Nippon Kayaku Co., Ltd.). Examples of commercially available products of the epoxy resin represented by Formula (i) include “jER (registered trademark)” 1031S (Mitsubishi Chemical Corporation).

Incidentally, epoxy resins other than the constituent [A] can be blended in the epoxy resin composition in the present invention. Examples of the epoxy resins other than the constituent [A] include a bisphenol A epoxy resin, a bisphenol F epoxy resin, a bisphenol S epoxy resin, a biphenyl epoxy resin, a naphthalene epoxy resin, an epoxy resin having a fluorene skeleton, a diglycidyl resorcinol, a glycidyl ether epoxy resin, and a N,N-diglycidyl aniline. As the epoxy resin, these may be used singly or in combination of plural kinds thereof.

The amount of the constituent [B] blended in the epoxy resin composition in the present invention is preferably an amount so that the number of active hydrogen groups in the constituent [B] with respect to the number of epoxy groups in all epoxy resins in the epoxy resin composition is 0.2 to 0.6. It is preferable to set the number of active hydrogen groups to be in this range since the effect of improving heat resistance by the secondary curing is great and a fiber-reinforced composite material exhibiting excellent heat resistance is likely to be obtained.

In the epoxy resin composition in the present invention, a thermoplastic resin can be blended as long as the effects of the present invention are not lost. As the thermoplastic resin, a thermoplastic resin soluble in the epoxy resin, organic particles such as rubber particles and thermoplastic resin particles, and the like can be blended.

Examples of the thermoplastic resin soluble in the epoxy resin include polyvinyl, acetal resins such as polyvinyl formal and polyvinyl butyral, polyvinyl alcohol, a phenoxy resin, polyamide, polyimide, polyvinyl pyrrolidone, and polysulfone.

Examples of the rubber particles include crosslinked rubber particles and core shell rubber particles obtained by graft polymerization of different polymers on the surface of the crosslinked rubber particles.

The reinforced fibers to be used in the present invention is not particularly limited, and a glass fiber, a carbon fiber, an aramid fiber, a boron fiber, an alumina fiber, a silicon carbide fiber and the like are used. Two or more kinds of these fibers may be used in mixture. Among these, it is preferable to use a carbon fiber capable of providing a lightweight and highly stiff fiber-reinforced composite material.

For the preparation of the epoxy resin composition to be used in the present invention, for example, a kneader, a planetary mixer, a triple roll mil, and a twin screw extruder may be used for kneading or kneading may be performed by hand using a beaker and a spatula as long as uniform kneading is possible.

The prepreg to be used in the present invention can be obtained by impregnating a reinforced fiber substrate with an epoxy resin composition. Examples of the impregnation method include hot-melt process (dry method).

The hot-melt process is a method in which a reinforced fiber is directly impregnated with an epoxy resin composition of which the viscosity is decreased by heating. Specifically, the hot-melt process is a method in which a film is produced by coating a release paper or the like with an epoxy resin composition, subsequently the film is stacked from both sides or one side of a sheet obtained by arranging reinforced fibers or a knitted fabric (cloth) of reinforced fibers, and heat and pressure is applied to the stacked body to impregnate the reinforced fibers with the resin.

As the method for producing a fiber-reinforced composite material of the present invention, a press molding method or an internal pressure molding method is preferably used. The internal pressure molding method is a molding method in which an internal pressure applying member with a tube or bag-shape is disposed inside a prepreg and a high pressure gas is introduced into the internal pressure applying member to apply pressure to the prepreg, thereby applying heat and pressure and performing primary curing.

The fiber-reinforced composite material produced by the present invention is preferably used in sports applications, general industrial applications, and aerospace applications. More specifically, the fiber-reinforced composite material is preferably used in golf shafts, fishing rods, tennis and badminton rackets, sticks for hockey and the like, ski poles and the like in sports applications. Furthermore, the fiber-reinforced composite material is preferably used in structural materials and interior materials for moving bodies such as motor vehicles, motorcycles, bicycles, ships, and railway vehicles, drive shafts, leaf springs, windmill blades, pressure vessels, flywheels, paper rollers, roofing materials, cables, repair and reinforcement materials and the like in general industrial applications.

### EXAMPLES

Hereinafter, the present invention will be described more specifically with reference to Examples, but the present invention is not limited to the description of these Examples.

The measurement of various physical properties was performed in an environment at a temperature of 23° C. and a relative humidity of 50% unless otherwise stated.

The materials used to mold the respective fiber-reinforced composite materials are as follows.

<Materials Used>

Constituent [A]: tri- or higher functional epoxy resin having aromatic ring
“SUMI-EPDXY (registered trademark)” ELM434 (diaminodiphenylmethane epoxy resin, epoxy equivalent weight: 120, manufactured by Sumitomo Chemical Co., Ltd.).
“jER (registered trademark)” 1031S (tetraphenol epoxy (compound represented by Formula (i)), epoxy equivalent weight: 200, manufactured by Mitsubishi Chemical Corporation).

Epoxy resin other than constituent [A]
“jER (registered trademark)” 828 (bisphenol A epoxy resin, epoxy equivalent weight: 189, manufactured by Mitsubishi Chemical Corporation).
“TEPIC (registered trademark)”-S (isocyanurate epoxy resin, epoxy equivalent weight: 100, manufactured by Nissan Chemical Corporation).

Constituent [B]: aromatic amine curing agent
SEIKACURE-S (4,4′-diaminodiphenyl sulfone, manufactured by SEIKA CORPORATION).

Constituent [C]: curing accelerator
“CUREZOL (registered trademark)” 2P4MHZ (2-phenyl-4-methyl-5-hydroxymethylimidazole, manufactured by SHIKOKU CHEMICALS CORPORATION).
“CUREDUCT (registered trademark)” P-0505 (adduct of bisphenol A diglycidyl ether and imidazole, manufactured by SHIKOKU CHEMICALS CORPORATION).

Other Components
“SUMIKA EXCEL (registered trademark)” PES 5003P (polyethersulfone, manufactured by Sumitomo Chemical Co., Ltd.)

<Method for Preparing Epoxy Resin Composition>

An epoxy resin of the constituent [A], an epoxy resin other than the constituent [A], and other components were put into a kneader. While kneading these, the temperature was raised to 150° C. and then kept at the same temperature for 1 hour to obtain a transparent viscous liquid. The temperature was lowered to 60° C. while continuously performing kneading, and then the constituent [B] and the constituent [C] were put into the kneader, and the mixture was kneaded for 30 minutes at the same temperature to obtain an epoxy resin composition. The compositions of the epoxy resin compositions of the respective Examples and Comparative Examples are presented in Tables 1 to 3.

<Method for Producing Cured Epoxy Resin>

An epoxy resin composition prepared in conformity with the <method for preparing epoxy resin composition> described above was degassed in a vacuum and then cured at 180° C. for 30 minutes in a mold set so as to have a thickness of 2 mm by a 2 mm thick “Teflon (registered trademark)” spacer to obtain a plate-shaped cured epoxy resin having a thickness of 2 mm. Thereafter, the cured epoxy resin obtained was heated in an oven heated to 240° C. for 30 minutes.

<Method for producing prepreg>

An epoxy resin composition prepared in conformity with the <method for preparing epoxy resin composition> described above was applied onto release paper using a film coater to produce a resin film having a basis weight of 31 g/m². The resin film produced was set in a prepregging apparatus and heat and pressure was applied thereto to impregnate carbon fibers “Torayca (registered trademark)” T700S (manufactured by Toray Industries, Inc., basis weight 125 g/m²) arranged in one direction to form a sheet with the resin from both sides of the carbon fibers. The resin content in the prepreg was 67% by mass.

<Method 1 for Producing Fiber-Reinforced Composite Material>

The fiber directions of the unidirectional prepreg obtained in the <method for producing prepreg> described above were arranged in order to obtain a prepreg laminate in which 19 sheets were laminated. The prepreg laminate was disposed on the lower mold of the mold, the upper mold was lowered, and the mold was tightened. A predetermined pressure was applied to the mold; the temperature was raised to a predetermined temperature at a temperature raising rate of 5° C./min and held for 60 minutes to primarily cure the prepreg laminate. Next, the molded article was taken out from the mold and subjected to secondary curing in a hot air oven heated to a predetermined temperature, thereby obtaining a flat fiber-reinforced composite material. The curing conditions in the respective Examples and Comparative Examples are presented in Tables 1 to 3.

<Method 2 for Producing Fiber-Reinforced Composite Material>

A tube-shaped internal pressure applying member was inserted into a mandrel, and seven unidirectional prepregs obtained by the <method for producing prepreg> described above were wound around the tube so that the arrangement directions of carbon fibers were [0°/+45°/−45°/+45°/−45°/0°/0° ]. Thereafter, the mandrel was pulled out from the tube to obtain a preform. The preform was disposed on the lower mold of the mold, the upper mold was lowered, and the mold was tightened. A predetermined pressure was applied to the preform by injecting air pressure into the tube, the temperature was raised to a predetermined temperature at a temperature raising rate of 5° C./min and held for 60 minutes to primarily cure the preform. Next, the molded article was taken out from the mold and subjected to secondary curing in a hot air oven heated to a predetermined temperature, thereby obtaining a tubular fiber-reinforced composite material. The curing conditions in the respective Examples and Comparative Examples are presented in Tables 1 to 3.

<Method for Evaluating Physical Properties>

(1) Viscosity Property of Epoxy Resin Composition

Here, the viscosity of an epoxy resin composition obtained by the <method for preparing epoxy resin composition> described above was measured at a temperature raising rate of 1.5° C./min in a measurement temperature range of 40° C. to 140° C. in a torsion mode (measurement frequency: 0.5 Hz) after setting the epoxy resin composition so that the distance between the upper and lower jigs was 1 mm using a dynamic viscoelasticity apparatus ARES-2KFRTN1-FCO-STD (manufactured by TA Instruments) and a flat parallel plate with a diameter of 40 mm as the upper and lower measurement jigs.

(2) Glass Transition Temperature of Cured Epoxy Resin

A test piece having a width of 10 mm, a length of 40 mm, and a thickness of 2 mm was cut out from a cured epoxy resin produced in conformity with the <method for producing cured epoxy resin> described above, the deformation mode was set to cantilevered bending, the span was set to 18 mm, the strain was set to 20 μm, the frequency was set to 1 Hz, and the measurement was performed under the condition of constant temperature increase of 5° C./rain from 40° C. to 200° C. using a dynamic viscoelasticity measuring apparatus (DMA-Q800: manufactured by TA Instruments). The onset temperature of the storage elastic modulus in the storage elastic modulus-temperature curve attained was taken as the glass transition temperature (Tg).

(3) Method for Evaluating Appearance Quality of Fiber-Reinforced Composite Material

The appearance quality of a fiber-reinforced composite material produced in conformity with the <method 1 for producing fiber-reinforced composite material> or <method 2 for producing fiber-reinforced composite material> described above was visually evaluated based on the presence or absence of defects such as pits, fiber disturbance, and resin blurring. Those not having defects were judged as “A”, those having some defects at a level having no problem were judged as “B”, and those having a number of defects and poor appearance were judged as “C”.

### Example 1

An epoxy resin composition was prepared in conformity with the <method for preparing epoxy resin composition> described above using 50 parts by mass of “SUMI-EPDXY (registered trademark)” ELM434 and 25 parts by mass of “jER (registered trademark)” 1031S as the constituent [A], 25 parts by mass of “jER (registered trademark)” 828 as another epoxy resin, 16.7 parts by mass of “SEIKACURE (registered trademark)”-S as the constituent [B], and 1.0 part by mass of “CUREZOL (registered trademark)” P-0505 as the constituent [C].

The dynamic viscoelasticity of this epoxy resin composition was measured, as a result, Log(η40)−Log(ηmin) was 2.9, and the resin flow property were favorable.

A cured epoxy resin was produced from the epoxy resin composition obtained in conformity with the <method for producing cured epoxy resin>. The glass transition temperature (Tg) of this cured epoxy resin was measured, as a result, the Tg was 237° C., and the heat resistance was favorable. In addition, a flat carbon fiber-reinforced composite material (CFRP) was produced from the epoxy resin composition obtained in conformity with the <method 1 for producing fiber-reinforced composite material> described above. The appearance thereof was evaluated, and the result was A as fiber disturbance, resin blurring, and pits were not observed.

### Examples 2 to 11, 14, and 15

Epoxy resin compositions, cured epoxy resins, and flat CFRPs were produced by the same methods as in Example 1 except that the resin composition and curing conditions were changed as presented in Table 1 or 2, respectively.

For the respective Examples, the flow property of epoxy resin composition, the Tg of cured epoxy resins and CFRPs, and the appearance evaluation were all favorable as presented in Table 1 or 2.

In addition, for Examples 5, 7, and 9, tubular CFRPs were produced in conformity with the <method 2 for producing fiber-reinforced composite material> described above. The appearance thereof was evaluated, and the result was A as fiber disturbance, resin blurring, and pits were not observed.

### Example 12

An epoxy resin composition, a cured epoxy resin, and a flat CFRP were produced by the same methods as in Example 1 except that the resin composition was changed as presented in Table 2. The cured epoxy resin had a Tg of 232° C. and the heat resistance thereof was favorable. The dynamic viscoelasticity of the epoxy resin composition was measured, and as a result, Log (η40)−Log(ηmin) was 3.6 to be high. As a result, in the appearance evaluation of CFRP, slight fiber disturbance was observed at a level having no problem.

In addition, a tubular CFRP was produced in conformity with the <method 2 for producing fiber-reinforced composite material> described above. The appearance thereof was evaluated, and as a result, slight fiber disturbance was observed at a level having no problem.

### Example 13

An epoxy resin composition, a cured epoxy resin, and a flat CFRP were produced by the same methods as in Example 1 except that the resin composition was changed as presented in Table 2. The cured epoxy resin had a Tg of 224° C. and the heat resistance thereof was favorable. The dynamic viscoelasticity of the epoxy resin composition was measured, and as a result, Log(η40)−Log(ηmin) was 2.4 to be low. As a result, in the appearance evaluation of CFRP, slight pits were observed at a level having no problem.

In addition, a tubular CFRP was produced in conformity with the <method 2 for producing fiber-reinforced composite material> described above. The appearance thereof was evaluated, and as a result, slight pits were observed at a level having no problem.

### Comparative Example 1

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The cured epoxy resin had a favorable Tg. However, the pressure applied at the time of CFRP production was 0.05 MPa to be low and the resin flow at the time of molding decreased, thus the appearance quality was poor as a number of pits were observed in the appearance evaluation of the CFRP obtained.

### Comparative Example 2

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The cured epoxy resin had a favorable Tg. However, the pressure applied at the time of CFRP production was 4.0 MPa to be high and the resin flow at the time of molding increased, thus the appearance quality was poor as fiber disturbance and resin blurring were observed at a number of places in the appearance evaluation of the CFRP obtained.

In addition, a tubular CFRP was produced in conformity with the <method 2 for producing fiber-reinforced composite material> described above. The appearance thereof was evaluated, and the appearance quality was poor as fiber disturbance and resin blurring were observed at a number of places.

### Comparative Example 3

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The flow property of the epoxy resin composition and the appearance of CFRP were favorable. However, the secondary curing temperature was 200° C. to be low, thus the CFRP had a low Tg and the heat resistance thereof was insufficient.

### Comparative Example 4

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The flow property of the epoxy resin composition and the appearance of CFRP were favorable. However, the secondary curing temperature was 280° C. to be high, thus the CFRP had a low Tg and the heat resistance thereof was insufficient.

### Comparative Example 5

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The flow property of the epoxy resin composition and the appearance of CFRP were favorable. However, the secondary curing time was 5 minutes to be short, thus the CFRP had a low Tg and the heat resistance thereof was insufficient.

### Comparative Example 6

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The flow property of the epoxy resin composition and the appearance of CFRP were favorable. However, no secondary curing was performed, thus the CFRP had a low Tg and the heat resistance thereof was insufficient.

### Comparative Example 7

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The CFRP had a favorable Tg. However, pressure was not applied at the time of CFRP production, thus the resin flow at the time of molding decreased, and the appearance quality was poor as a number of pits were observed in the appearance evaluation of the CFRP obtained.

### Comparative Example 8

An epoxy resin composition was produced by the same method as in Example 1 to have the same resin composition as in Example 1, and a cured epoxy resin and a flat CFRP were produced under the curing conditions described in Table 3. The evaluation results on the physical properties are presented together in Table 3. The CFRP had a favorable Tg. However, the primary curing temperature was 220° C. to be high, thus the resin flow at the time of molding increased, and the appearance quality was poor as fiber disturbance and resin blurring were observed at a number of places in the appearance evaluation of the CFRP obtained.

TABLE 1-1

| | | | | Example | Example | Example | Example |
|---|---|---|---|---|---|---|---|
| | Component | | | 1 | 2 | 3 | 4 |
| Constituent | [A] a tri- or higher | “SUMI-EPOXY ®” ELM434 | | 50 | 60 | 60 | 60 |
| | functional epoxy resin | “jER ®” 1031S | | 25 | 30 | 30 | 30 |
| | having an aromatic ring | | | | | | |
| | Another epoxy resin | “jER ®” 828 | | 25 | 10 | 10 | 10 |
| | [B] an aromatic amine | 4,4′-DDS | | 16.7 | 27.0 | 17.4 | 17.4 |
| | [C] a curing accelerator | “CUREZOL ®” 2P4MHZ | | | | 1.0 | |
| | | “CUREZOL ®” P-0505 | | 1.0 | 1.0 | | 1.0 |
| | Ratio of number of active hydrogen in [B] to number of epoxy | | | 0.40 | 0.62 | 0.40 | 0.40 |
| | groups in all epoxy resins | | | | | | |
| Curing | Primary curing | Temperature | ° C. | 180 | 180 | 180 | 180 |
| conditions | condition | Pressure | MPa | 1.2 | 1.2 | 1.2 | 1.2 |
| | Secondary curing | Temperature | ° C. | 240 | 240 | 240 | 210 |
| | condition | Time | Minutes | 30 | 30 | 30 | 30 |
| Properties of | Uncured resin | Viscosity at 40° C. (η40) | Pa · s | 1050 | 2730 | 1290 | 2410 |
| resin | | Minimum viscosity (ηmin) | Pa · s | 1.2 | 2.1 | 0.8 | 2.2 |
| | | log(η40) - log(ηmin) | | 2.9 | 3.1 | 3.2 | 3.0 |
| | | Temperature providing | ° C. | 101 | 98 | 113 | 102 |
| | | minimum viscosity | | | | | |
| | Cured product | Glass transition | ° C. | 237 | 235 | 233 | 251 |
| | (cured at 180° C. for 30 | temperature (Tg) | | | | | |
| | minutes + at 240° C. for | | | | | | |
| | 30 minutes) | | | | | | |
| Properties of | Heat resistance | Glass transition | ° C. | 235 | 233 | 230 | 234 |
| CFRP | | temperature (Tg) | | | | | |

| | | | | | |
|---|---|---|---|---|---|
| Appearance evaluation | Production method 1 | A | A | A | A |
| | Production method 2 | — | — | — | — |

TABLE 1-2

| | | | | Example | Example | Example | Example |
|---|---|---|---|---|---|---|---|
| | Component | | | 5 | 6 | 7 | 8 |
| Constituent | [A] a tri- or higher | “SUMI-EPOXY ®” ELM434 | | 60 | 60 | 60 | 60 |
| | functional epoxy resin | “jER ®” 1031S | | 30 | 30 | 30 | 30 |
| | having an aromatic ring | | | | | | |
| | Another epoxy resin | “jER ®” 828 | | 10 | 10 | 10 | 10 |
| | [B] an aromatic amine | 4,4′-DDS | | 17.4 | 17.4 | 17.4 | 17.4 |
| | [C] a curing accelerator | “CUREZOL ®” 2P4MHZ | | | | | |
| | | “CUREZOL ®” P-0505 | | 1.0 | 1.0 | 1.0 | 1.0 |
| | Ratio of number of active hydrogen in [B] to number of epoxy | | | 0.40 | 0.40 | 0.40 | 0.40 |
| | groups in all epoxy resins | | | | | | |
| Curing | Primary curing | Temperature | ° C. | 180 | 180 | 180 | 180 |
| conditions | condition | Pressure | MPa | 1.2 | 1.2 | 1.2 | 1.2 |
| | Secondary curing | Temperature | ° C. | 220 | 230 | 240 | 250 |
| | condition | Time | Minutes | 30 | 30 | 30 | 30 |
| Properties of | Uncured resin | Viscosity at 40° C. (η40) | Pa · s | 2410 | 2410 | 2410 | 2410 |
| resin | | Minimum viscosity (ηmin) | Pa · s | 2.2 | 2.2 | 2.2 | 2.2 |
| | | log(η40) - log(ηmin) | | 3.0 | 3.0 | 3.0 | 3.0 |
| | | Temperature providing | ° C. | 102 | 102 | 102 | 102 |
| | | minimum viscosity | | | | | |
| | Cured product | Glass transition | ° C. | 251 | 251 | 251 | 251 |
| | (cured at 180° C. for 30 | temperature (Tg) | | | | | |
| | minutes + at 240° C. for | | | | | | |
| | 30 minutes) | | | | | | |
| Properties of | Heat resistance | Glass transition | ° C. | 240 | 246 | 248 | 243 |
| CFRP | | temperature (Tg) | | | | | |

| | | | | | |
|---|---|---|---|---|---|
| Appearance evaluation | Production method 1 | A | A | A | A |
| | Production method 2 | A | — | A | — |

TABLE 2-1

| | | | | Example | Example | Example | Example |
|---|---|---|---|---|---|---|---|
| | Component | | | 9 | 10 | 11 | 12 |
| Constituent | [A] a tri- or higher | “SUMI-EPOXY ®” ELM434 | | 60 | 60 | 60 | 60 |
| | functional epoxy resin | “jER ®” 1031S | | 30 | 30 | 30 | 30 |
| | having an aromatic ring | | | | | | |
| | Another epoxy resin | “jER ®” 828 | | 10 | 10 | 10 | 10 |
| | | “TEPIC ®”-S | | | | | |
| | [B] an aromatic amine | 4,4′-DDS | | 17.4 | 17.4 | 17.4 | 17.4 |
| | [C] a curing accelerator | “CUREZOL ®” P-0505 | | 1.0 | 1.0 | 1.0 | 0.5 |
| | Other components | “SUMIKA EXCEL ®” PES 5003P | | | | | |
| | Ratio of number of active hydrogen in [B] to number of epoxy | | | 0.40 | 0.40 | 0.40 | 0.40 |
| | groups in all epoxy resins | | | | | | |
| Curing | Primary curing | Temperature | ° C. | 180 | 180 | 180 | 180 |
| conditions | condition | Pressure | MPa | 1.2 | 1.2 | 1.2 | 1.2 |
| | Secondary curing | Temperature | ° C. | 260 | 270 | 240 | 240 |
| | condition | Time | Minutes | 30 | 30 | 15 | 30 |
| Properties of | Uncured resin | Viscosity at 40° C. (η40) | Pa · s | 2410 | 2410 | 2410 | 2400 |
| resin | | Minimum viscosity (ηmin) | Pa · s | 2.2 | 2.2 | 2.2 | 0.6 |
| | | log(η40) - log(ηmin) | | 3.0 | 3.0 | 3.0 | 3.6 |
| | | Temperature providing | ° C. | 102 | 102 | 102 | 110 |
| | | minimum viscosity | | | | | |
| | Cured product | Glass transition | ° C. | 251 | 251 | 251 | 255 |
| | (cured at 180° C. for 30 | temperature (Tg) | | | | | |
| | minutes + at 240° C. for | | | | | | |
| | 30 minutes) | | | | | | |
| Properties of | Heat resistance | Glass transition | ° C. | 237 | 231 | 240 | 252 |
| CFRP | | temperature (Tg) | | | | | |

| | | | | | |
|---|---|---|---|---|---|
| Appearance evaluation | Production method 1 | A | A | A | B |
| | Production method 2 | A | — | — | B |

TABLE 2-2

| | | | | Example | Example | Example |
|---|---|---|---|---|---|---|
| | Component | | | 13 | 14 | 15 |
| Constituent | [A] a tri- or higher | “SUMI-EPOXY ®” ELM434 | | 60 | 60 | 60 |
| | functional epoxy resin | “jER ®” 1031S | | | 30 | 30 |
| | having an aromatic ring | | | | | |
| | Another epoxy resin | “jER ®” 828 | | | 10 | 10 |
| | | “TEPIC ®”-S | | 40 | | |
| | [B] an aromatic amine | 4,4′-DDS | | 22.3 | 17.4 | 17.4 |
| | [C] a curing accelerator | “CUREZOL ®” P-0505 | | 1.5 | 1.0 | 1.0 |
| | Other components | “SUMIKA EXCEL ®” PES 5003P | | 4.0 | | |
| | Ratio of number of active hydrogen in [B] to number of epoxy | | | 0.40 | 0.40 | 0.40 |
| | groups in all epoxy resins | | | | | |
| Curing | Primary curing | Temperature | ° C. | 180 | 180 | 180 |
| conditions | condition | Pressure | MPa | 1.2 | 0.5 | 2.5 |
| | Secondary curing | Temperature | ° C. | 240 | 240 | 240 |
| | condition | Time | Minutes | 30 | 30 | 30 |
| Properties of | Uncured resin | Viscosity at 40° C. (η40) | Pa · s | 2279 | 2410 | 2410 |
| resin | | Minimum viscosity (ηmin) | Pa · s | 8.8 | 2.2 | 2.2 |
| | | log(η40) - log(ηmin) | | 2.4 | 3.0 | 3.0 |
| | | Temperature providing | ° C. | 118 | 102 | 102 |
| | | minimum viscosity | | | | |
| | Cured product | Glass transition | ° C. | 224 | 251 | 251 |
| | (cured at 180° C. for 30 | temperature (Tg) | | | | |
| | minutes + at 240° C. for | | | | | |
| | 30 minutes) | | | | | |
| Properties of | Heat resistance | Glass transition | ° C. | 221 | 247 | 248 |
| CFRP | | temperature (Tg) | | | | |

| | | | | |
|---|---|---|---|---|
| Appearance evaluation | Production method 1 | B | A | A |
| | Production method 2 | B | — | — |

TABLE 3-1

| | | | | Comparative | Comparative | Comparative | Comparative |
|---|---|---|---|---|---|---|---|
| | Component | | | Example 1 | Example 2 | Example 3 | Example 4 |
| Constituent | [A] a tri- or higher | “SUMI-EPOXYS” ELM434 | | 60 | 60 | 60 | 60 |
| | functional epoxy resin | “jER ®” 1031S | | 30 | 30 | 30 | 30 |
| | having an aromatic ring | | | | | | |
| | Another epoxy resin | “jER ®” 828 | | 10 | 10 | 10 | 10 |
| | [B] an aromatic amine | 4,4′-DDS | | 17.4 | 17.4 | 17.4 | 17.4 |
| | [C] a curing accelerator | “CUREZOL ®” P-0505 | | 1.0 | 1.0 | 1.0 | 1.0 |
| | Ratio of number of active hydrogen in [B] to number of epoxy | | | 0.40 | 0.40 | 0.40 | 0.40 |
| | groups in all epoxy resins | | | | | | |
| Curing | Primary curing | Temperature | ° C. | 180 | 180 | 180 | 180 |
| conditions | condition | Pressure | MPa | 0.05 | 4.0 | 1.2 | 1.2 |
| | Secondary curing | Temperature | ° C. | 240 | 240 | 200 | 280 |
| | condition | Time | Minutes | 30 | 30 | 30 | 30 |
| Properties of | Uncured resin | Viscosity at 40° C. (η40) | Pa · s | 2410 | 2410 | 2410 | 2410 |
| resin | | Minimum viscosity (ηmin) | Pa · s | 2.2 | 2.2 | 2.2 | 2.2 |
| | | log(η40) - log(ηmin) | | 3.0 | 3.0 | 3.0 | 3.0 |
| | | Temperature providing | ° C. | 102 | 102 | 102 | 102 |
| | | minimum viscosity | | | | | |
| | Cured product | Glass transition | ° C. | 251 | 251 | 251 | 251 |
| | (cured at 180° C. for 30 | temperature (Tg) | | | | | |
| | minutes + at 240° C. for | | | | | | |
| | 30 minutes) | | | | | | |
| Properties of | Heat resistance | Glass transition | ° C. | 246 | 249 | 214 | 211 |
| CFRP | | temperature (Tg) | | | | | |

| | | | | | |
|---|---|---|---|---|---|
| Appearance evaluation | Production method 1 | C | C | A | A |
| | Production method 2 | — | C | — | — |

TABLE 3-2

| | | | | Comparative | Comparative | Comparative | Comparative |
|---|---|---|---|---|---|---|---|
| | Component | | | Example 5 | Example 6 | Example 7 | Example 8 |
| Constituent | [A] a tri- or higher | “SUMI-EPOXYS” ELM434 | | 60 | 60 | 60 | 60 |
| | functional epoxy resin | “jER ®” 1031S | | 30 | 30 | 30 | 30 |
| | having an aromatic ring | | | | | | |
| | Another epoxy resin | “jER ®” 828 | | 10 | 10 | 10 | 10 |
| | [B] an aromatic amine | 4,4′-DDS | | 17.4 | 17.4 | 17.4 | 17.4 |
| | [C] a curing accelerator | “CUREZOL ®” P-0505 | | 1.0 | 1.0 | 1.0 | 1.0 |
| | Ratio of number of active hydrogen in [B] to number of epoxy | | | 0.40 | 0.40 | 0.40 | 0.40 |
| | groups in all epoxy resins | | | | | | |
| Curing | Primary curing | Temperature | ° C. | 180 | 180 | 180 | 220 |
| conditions | condition | Pressure | MPa | 1.2 | 1.2 | 0 | 1.2 |
| | Secondary curing | Temperature | ° C. | 240 | — | 240 | 240 |
| | condition | Time | Minutes | 5 | — | 30 | 30 |
| Properties of | Uncured resin | Viscosity at 40° C. (η40) | Pa · s | 2410 | 2410 | 2410 | 2410 |
| resin | | Minimum viscosity (ηmin) | Pa · s | 2.2 | 2.2 | 2.2 | 2.2 |
| | | 1og(η40) - log(ηmin) | | 3.0 | 3.0 | 3.0 | 3.0 |
| | | Temperature providing | ° C. | 102 | 102 | 102 | 102 |
| | | minimum viscosity | | | | | |
| | Cured product | Glass transition | ° C. | 251 | 251 | 251 | 251 |
| | (cured at 180° C. for 30 | temperature (Tg) | | | | | |
| | minutes + at 240° C. for | | | | | | |
| | 30 minutes) | | | | | | |
| Properties of | Heat resistance | Glass transition | ° C. | 218 | 211 | 244 | 248 |
| CFRP | | temperature (Tg) | | | | | |

| | | | | | |
|---|---|---|---|---|---|
| Appearance evaluation | Production method 1 | A | A | C | C |
| | Production method 2 | — | — | — | — |

### INDUSTRIAL APPLICABILITY

According to the method for producing a fiber-reinforced composite material of the present invention, it is possible to obtain a fiber-reinforced composite material exhibiting high heat resistance and excellent appearance quality. The fiber-reinforced composite material produced by the present invention is preferably used in sports applications and general industrial applications.

1. A method for producing a fiber-reinforced composite material, the method comprising:
disposing a prepreg containing a reinforced fiber being impregnated with an epoxy resin composition in a mold; pressurizing and heating the prepreg at 0.2 to 2.5 MPa and 130° C. to 200° C. as primary curing; and then
further heating the prepreg at 210° C. to 270° C. for 10 minutes or more as secondary curing.

2. The method for producing a fiber-reinforced composite material according to claim 1, wherein
an internal pressure applying member with a tube or bag-shape is disposed inside the prepreg, and
a high pressure gas is introduced into the internal pressure applying member to apply pressure to the prepreg during the primary curing.

3. The method for producing a fiber-reinforced composite material according to claim 1 or 2, wherein the epoxy resin composition satisfies condition (1) below:
(1) a glass transition temperature of a cured product obtained by subjecting the epoxy resin composition to curing at 180° C. for 30 minutes and then to curing at 240° C. for 30 minutes is 220° C. or more.

4. The method for producing a fiber-reinforced composite material according to any one of claims 1 to 3, wherein the epoxy resin composition satisfies condition (2) below:
(2) a resin viscosity (η40) at 40° C. and a minimum viscosity (ηmin) satisfy a relational expression of:
2.5<Log(η40)−Log(ηmin)≤3.5.

5. The method for producing a fiber-reinforced composite material according to any one of claims 1 to 4, wherein the epoxy resin composition satisfies condition (3) below:
(3) a minimum viscosity when a viscosity is measured at a temperature raising rate of 1.5° C./min is in a range of 90° C. to 120° C. and a value of the minimum viscosity is 4.0 Pa·s or less.

6. The method for producing a fiber-reinforced composite material according to any one of claims 1 to 5, wherein the epoxy resin composition is an epoxy resin composition containing constituents [A] to [C] below:
[A] a tri- or higher functional epoxy resin having an aromatic ring
[B] an aromatic amine curing agent
[C] a curing accelerator

7. The method for producing a fiber-reinforced composite material according to claim 6, wherein the constituent [A] is contained in an amount of 80 parts by mass or more in 100 parts by mass of all epoxy resins in the epoxy resin composition.

8. The method for producing a fiber-reinforced composite material according to claim 6 or 7, wherein the constituent [A] includes at least one selected from the group consisting of tetraglycidyldiaminodiphenylmethane, a novolac epoxy resin, and an epoxy resin represented by Formula (i) below:

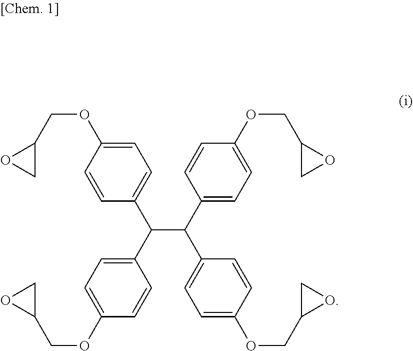 [SMILES: c1cc(C(c2ccc(OCC3CO3)cc2)C(c2ccc(OCC3CO3)cc2)c2ccc(OCC3CO3)cc2)ccc1OCC1CO1]

9. The method for producing a fiber-reinforced composite material according to any one of claims 6 to 8, wherein a number of active hydrogen groups in the constituent [B] with respect to a number of epoxy groups in all epoxy resins in the epoxy resin composition is 0.2 to 0.6.

10. The method for producing a fiber-reinforced composite material according to any one of claims 6 to 9, wherein the constituent [B] includes at least one selected from the group consisting of 4,4′-diaminodiphenyl sulfone and 3,3′-diaminodiphenyl sulfone.

11. The method for producing a fiber-reinforced composite material according to any one of claims 1 to 10, wherein the reinforced fiber is a carbon fiber.
